(19) United States
(12) Patent Application Publication
(10) Pub. No.: US 2013/0154248 A1
(43) Pub. Date: Jun. 20, 2013

(54) NOTEPADS, ASSEMBLIES INCORPORATING THE SAME, AND ASSOCIATED METHODS OF USE

(71) Applicant: Mark Knudsen, Grand Haven, MI (US)

(72) Inventor: Mark Knudsen, Grand Haven, MI (US)

(21) Appl. No.: 13/625,395

(22) Filed: Sep. 24, 2012

Related U.S. Application Data
(63) Continuation-in-part of application No. 13/022,306, filed on Feb. 7, 2011.
(60) Provisional application No. 61/301,963, filed on Feb. 5, 2010.

(51) Int. Cl. B42D 1/00

(52) U.S. Cl. CPC B42D 1/00
USPC 281/20

(57) ABSTRACT

A notepad for use in wet environments preferably having a base member, a plurality of sheets of natural and/or synthetic water resistant and/or waterproof paper stacked together to form a pad, wherein the base member is preferably folded over to cover the top edge of the pad, and preferably one or more securement members extending through a region where the base member is folded over the pad. Methods of using notepads, notepad assemblies, and associated individual notepad sheets are also disclosed.

### CROSS-REFERENCE TO RELATED APPLICATIONS

This application is a continuation-in-part of U.S. application Ser. No. 13/022,306, filed Feb. 7, 2011, entitled “Notepad and Assemblies Incorporating the Same” which claims the benefit of U.S. Provisional Application Ser. No. 61/301,963, filed Feb. 5, 2010, entitled “Disposable Notepad and Method of Using the Same,” which are hereby incorporated herein by reference in their entirety, including all references cited therein.

### BACKGROUND OF THE INVENTION

1. Field of the Invention

The present invention relates in general to notepads and, more particularly, but not by way of limitation, to disposable notepads that are adapted for use in wet environments, such as a kitchen, a shower, a bathtub, a pool, outdoors, and the like. The present invention further relates to notepad assemblies, as well as methods of using notepads, notepad assemblies, and associated individual notepad sheets.

2. Background Art

Notepads have been well known in the art for decades. While notepads have been well known in the art, commonly utilized notepads suffer from numerous drawbacks including, but not limited to, their lack of ability to be utilized in wet environments.

For example, commonly utilized notepads include a backing material associated with a plurality of sheets of paper stacked upon one another to form a pad. The backing material is most often constructed from a material such as fiberboard, cardboard, and/or paper that may be susceptible to absorbing water or other fluids. As such, the backing material often swells upon contact with a fluid and frequently permanently distorts in shape, even when the backing material dries. Additionally, fluid may wick from the backing material into the sheets of paper associated with the backing material, causing damage to the sheets of paper. It will be understood that the damage to the sheets of paper may include, but is not limited to, distorting guide rule lines and/or markings made by writing implements upon the sheets of paper, the latter often being the most deleterious effect.

Markings made by writing implements may be completely distorted and/or unrecognizable as the fluid permeates the sheets of paper and dilutes the markings.

Therefore, it is an object of the present invention to provide notepads and/or notepad assemblies that are adapted for use in wet environments which reduces and/or eliminates the aforementioned drawbacks associated with commonly available notepads.

It is a further object of the present invention to provide a method of utilizing one or more individual notepad sheets in a plurality of wet and/or dry environments toward eliminating the need for utilizing, for example, Post-it® brand notes and/or sheets of paper which are undesirably associated with adhesives and/or fasteners.

These and other objects of the present invention will become apparent in light of the present specification, claims, and appended drawings.

### SUMMARY OF THE INVENTION

In one embodiment, the present invention is directed to a notepad for use in wet environments, the notepad comprising, consisting of, and/or consisting essentially of: (a) a base member having a top surface and a bottom surface; (b) a plurality of sheets of natural and/or synthetic water resistant and/or waterproof paper stacked together to form a pad, the pad including a top sheet, a bottom sheet, and a top edge; (c) wherein the base member is folded over and covers the top edge of the pad; and (d) one or more securement members extending through a region where the base member is folded over the pad to join the pad to the base member, the securement members being adapted to releaseably connect the notepad to a surface.

In another embodiment, at least one of the top surface and the bottom surface of the base member include a waterproof coating.

In an additional embodiment, the top edge of the pad includes an adhesive, wherein when the pad is associated with the base member, the adhesive contacts at least a portion of the top surface of the base member when the base member is folded over the pad.

In yet another embodiment, each of the plurality of sheets of paper include a score line extending along a length thereof, the score line spaced apart from a top edge of the sheet of paper such that a lower edge of the base member folded over the top edge of the pad is substantially aligned with the score line.

In accordance with the present disclosure, the securement members include a head, an attachment member, and a post extending therebetween, the post extending through at least a portion of the region where the base member is folded over the pad.

In an alternate embodiment, the region where the base member is folded over the pad is captured between the head and the attachment member.

In an additional embodiment, the attachment member includes a suction cup, a hook, double sided tape, cord and/or string.

In yet another embodiment, the notepad comprises two securement members spaced apart from one another to define an area of the base member adapted to receive indicia.

In an alternative embodiment, the bottom surface of the base member includes one or more indicia.

In one embodiment, the present invention is directed to a notepad assembly for use in wet environments comprising, consisting of, and/or consisting essentially of: (a) a notepad having: (i) a base member having a top surface and a bottom surface; (ii) a plurality of sheets of natural and/or synthetic water resistant and/or waterproof paper stacked together to form a pad, the pad including a top sheet, a bottom sheet, and a top edge; (iii) wherein the base member is folded over and covers the top edge of the pad; and (iv) one or more securement members extending through a region where the base member is folded over the pad to join the pad to the base member, the securement members being adapted to releasably attach the notepad to a surface; (b) at least one writing implement adapted for marking sheets of paper having a waterproof coating; and (c) at least one securement member adapted to releasably retain the at least one writing implement, the at least one securement member adapted to releasably attach to a surface.

In another embodiment, at least one of the top surface and the bottom surface of the base member include a waterproof coating.

In an additional embodiment, the top edge of the pad includes an adhesive, wherein when the pad is associated with the base member, the adhesive contacts at least a portion of the top surface of the base member when the base member is folded over the pad.

In yet another embodiment, each of the plurality of sheets of paper include a score line extending along a length thereof, the score line spaced apart from a top edge of the sheet of paper such that a lower edge of the base member folded over the top edge of the pad is substantially aligned with the score line.

In accordance with the present disclosure, the securement members include a head, an attachment member, and a post extending therebetween, the post extending through at least a portion of the region where the base member is folded over the pad.

In an alternate embodiment, the region where the base member is folded over the pad is captured between the head and the attachment member.

In another embodiment, the attachment member includes a suction cup, a hook, double sided tape, cord and/or string.

In yet another embodiment, the notepad comprises two securement members spaced apart from one another to define an area of the base member adapted to receive indicia.

In an alternative embodiment, the bottom surface of the base member includes one or more indicia.

The present invention is also directed to a method of using a sheet of paper, comprising, consisting of, and/or consisting essentially of the steps of: (a) providing a sheet of paper having a top surface and a bottom surface, wherein the sheet of paper comprises at least one of a natural and/or synthetic material which is at least one of water resistant and/or waterproof; (b) moistening at least one of the top and bottom surfaces of the sheet of paper with an aqueous liquid; (c) applying the sheet of paper to a surface; and (d) releasably securing the sheet of paper to the surface with the aqueous liquid.

In a preferred embodiment of the present invention, the step of providing a sheet of paper comprises the step of providing adhesive free paper.

In another preferred embodiment of the present invention, the step of providing a sheet of paper comprises the step of providing a sheet of paper having indicia associated with at least one of the top and bottom surfaces of the sheet of paper.

In yet another preferred embodiment of the present invention, the step of applying the sheet of paper to a surface includes the step of applying the sheet of paper to a substantially non-porous and substantially vertical surface.

In another aspect of the present invention, the step of releasably securing the sheet of paper to the surface includes the step of releasably securing the sheet of paper to the surface for at least one hour.

In an additional preferred embodiment of the present invention, the method further comprises the step of removing the sheet of paper from the surface by an individual who did not apply the sheet of paper to the surface.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

FIG. 1 of the drawings is a perspective view of a notepad, constructed in accordance with the present invention;

FIG. 2 of the drawings is a cross-sectional view of the notepad of FIG. 1;

FIG. 3 of the drawings is a perspective view of a notepad assembly;

FIG. 4 of the drawings is a perspective view of a notepad constructed in accordance with the present invention showing an adhesive glue strip associated with sheets of paper to form a pad;

FIG. 5 of the drawings is a perspective view of a notepad constructed in accordance with the present invention showing a plastic coil binding sheets of paper together to form a pad/journal;

FIG. 6 of the drawings is a perspective view of a notepad constructed in accordance with the present invention showing a loop wire binding sheets of paper together to form a pad/journal;

FIG. 7 of the drawings is a perspective view of a notepad constructed in accordance with the present invention showing a saddle stitch or staples binding sheets of paper together to form a pad/booklet;

FIG. 8 of the drawings is a perspective view of a notepad constructed in accordance with the present invention showing tape-binding sheets of paper together to form a pad/book;

FIG. 9 of the drawings is a perspective view of a notepad constructed in accordance with the present invention showing a lanyard used to associate a notepad with a faucet handle and/or suction cup;

FIG. 10 of the drawings is a perspective view of a notepad constructed in accordance with the present invention showing a calendar coil associated with the notepad which is secured to a suction cup;

FIG. 11 of the drawings is a perspective view of a notepad constructed in accordance with the present invention showing a grommet used to associate a notepad with a faucet handle and/or suction cup;

FIG. 12 of the drawings is a perspective view of a notepad constructed in accordance with the present invention showing an aperture used to associate a notepad with a faucet handle and/or suction cup;

FIG. 13 of the drawings is a top plan view of a notepad constructed in accordance with the present invention associated with a C-clip;

FIG. 14 of the drawings is a perspective view of a notepad constructed in accordance with the present invention associated with a C-clip;

FIG. 15 of the drawings is an end view of a notepad constructed in accordance with the present invention associated with a C-clip; and

FIG. 16 of the drawings is a perspective view of a notepad constructed in accordance with the present invention associated with a C-clip.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

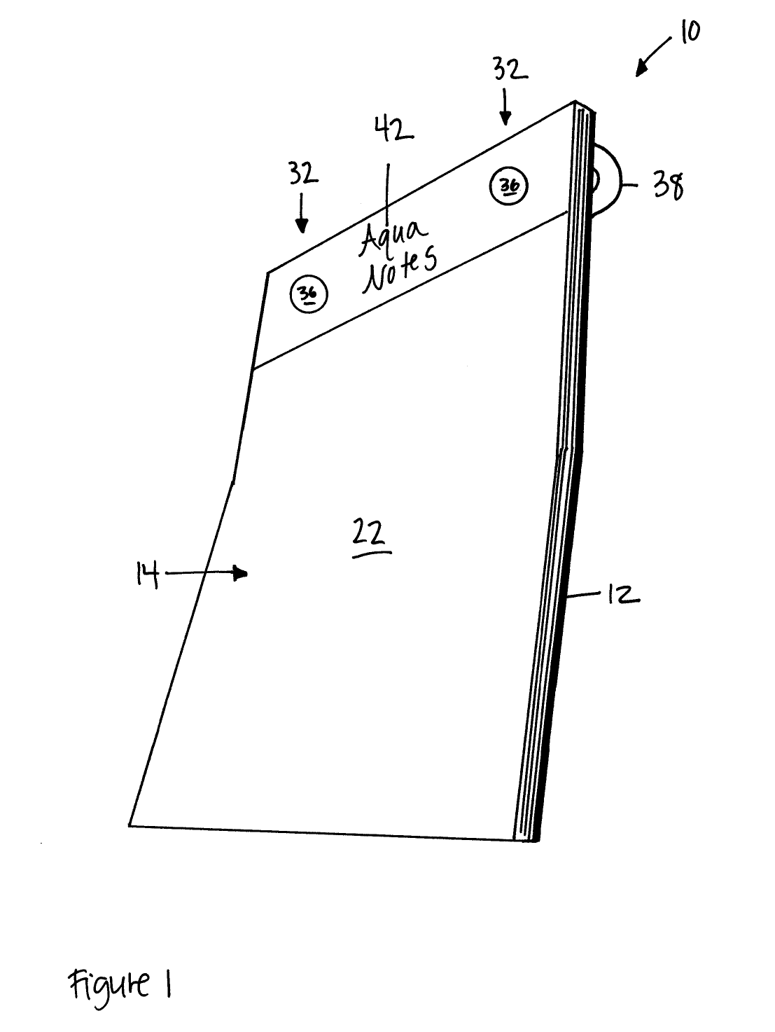

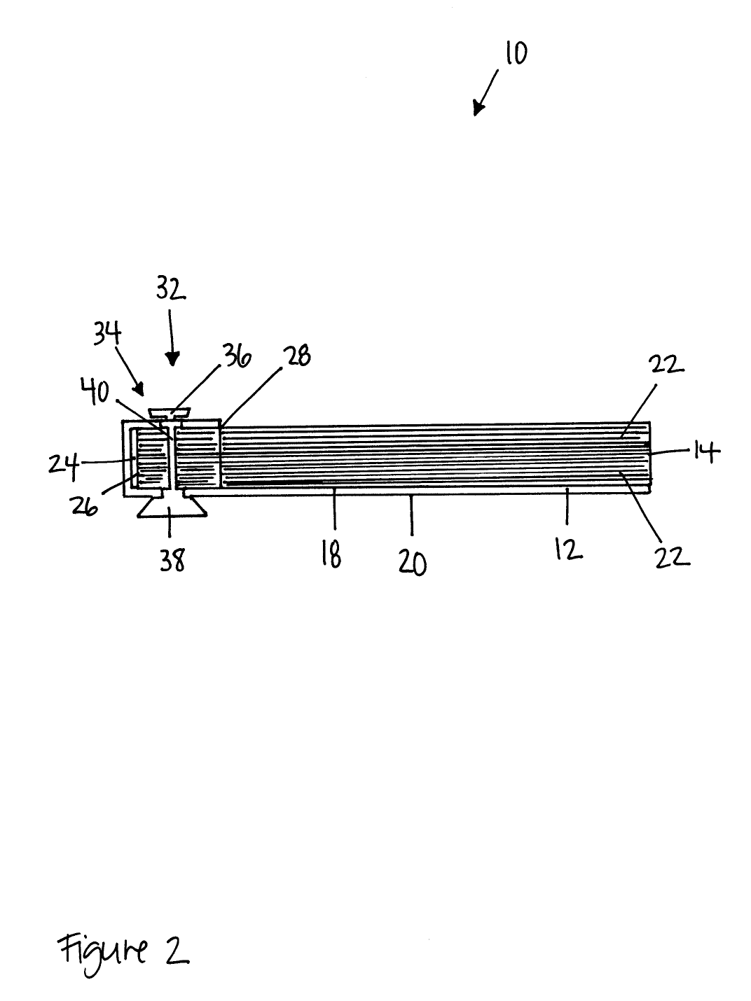

Referring now to the drawings, and more particularly to FIGS. 1 and 2 collectively, pad/notepad 10 is shown. It will be understood that pad/notepad 10 may comprise a pad/notepad, a binder, a book, a booklet, etcetera. Notepad 10 is adapted for use in wet environments, such as a shower, a bathtub, a pool, a boat, the outdoors, and the like. Generally speaking, notepad 10 is preferably disposable and may include base member 12 and pad 14.

Base member 12 may be constructed from a flexible and durable material such as paperboard, covered with a waterproof coating such as waterproof compounds (e.g., perfluorooctanesulfonamide, perfluorooctane sulfonate, etc.), waterproof membranes, durable water repellants (e.g., polytetrafluoroethylene), and the like. It will be understood that base member 12 may be fabricated from materials other than paperboard, such as leather, resins, polymers, rubbers, composites, and the like. Base member 12 may be formed from any of the above-described materials and may be fabricated as a rectangular sheet that includes top surface 18 and bottom surface 20. More specifically, base member 12 is sized such that it is slightly longer than pad 14.

Pad 14 includes a plurality of sheets of paper 22 stacked upon one another. Similarly to base member 12, each of the sheets of paper 22 may include a substantially water resistant, water non-absorbent, and/or waterproof coating on a top or bottom surface thereof. Alternatively, the paper may comprise natural and/or synthetic water resistant and/or waterproof paper (e.g., YUPO paper, Polyart® paper). By way of non-limiting example, sheets of paper 22 may include a vegetable parchment paper provided with a substantially non-absorbent and substantially non- reactive characteristics relative to fluids such as water. Such paper is available from commercial sources such as Ahlstrom of France. Additionally, U.S. Pat. No. 6,863,940, discloses paper suitable for use in accordance with the present invention. U.S. Pat. No. 6,863,940, is hereby incorporated by reference herein in its entirety—including all references cited therein.

In one embodiment, sheets of paper 22 are preferably joined together via adhesive 24 disposed along top edges 26 of sheets of paper 22. It will be understood that additional methods for joining together sheets of paper 22 that would be known to one of ordinary skill in the art having the present disclosure before them are likewise contemplated for use, including, for example, binding, stapling, loose leaf collecting, and the like. As will be discussed in greater detail below, sheets of paper 22 may also include score line 28 which allows sheets of paper 22 to be detachably removed from pad 14.

Pad 14 may be associated with base member 12 by placing the bottom surface of a last sheet of paper 22 against top surface 18 of base member 12. A portion of base member 12 extending above top edge 26 of sheets of paper 22 of pad 14 is folded over to cover at least a portion of pad 14. According to some embodiments, adhesive 24 may function to secure pad 14 to a portion of base member 12 folded over pad 14.

Moreover, as is best shown in FIG. 2, base member 12 may be folded over the top portion of pad 14, so that at least a portion of base member 12 covers at least a portion of pad 14. In some embodiments, base member 12 covers a portion of pad 14 down to score line 28 of sheets of paper 22. As such, the portion of base member 12 covering pad 14 defines a lower edge that creates a leverage point for detachably removing used sheets of paper 22 from pad 14.

In one embodiment, to releaseably secure pad 14 to base member 12, securement members 32 are placed through apertures that extend through region 34 where base member 12 is folded over pad 14. Generally speaking, securement members 32 each include head 36, attachment member 38, and post 40 extending therebetween.

Head 36 and attachment member 38 may be sized larger than the diameter of the apertures such that region 34 may be captured between head 36 and attachment member 38 to secure base member 12 and pad 14 together. According to exemplary embodiments, post 40 may extend from head 36 and attachment member 38 may releaseably couple onto a terminal end of post 40.

In accordance with the present disclosure, attachment member 38 may include a suction cup, a hook, a clip, and the like, and function to releaseably secure notepad 10 to a surface (not shown) such as a wall or a mirror.

According to some embodiments, notepad 10 may include indicia 42 disposed on various portions of notepad 10. Indicia 42 may include informational text disclosing a method of use for notepad 10, a trade name of notepad 10, or other useful, whimsical, informational, or commercial markings. It will be understood that indicia 42 may also include pictures, symbols, and the like.

In some embodiments, a first indicia 42 may be placed upon the area between securement members 32 and a second along bottom surface 20 of base member 12.

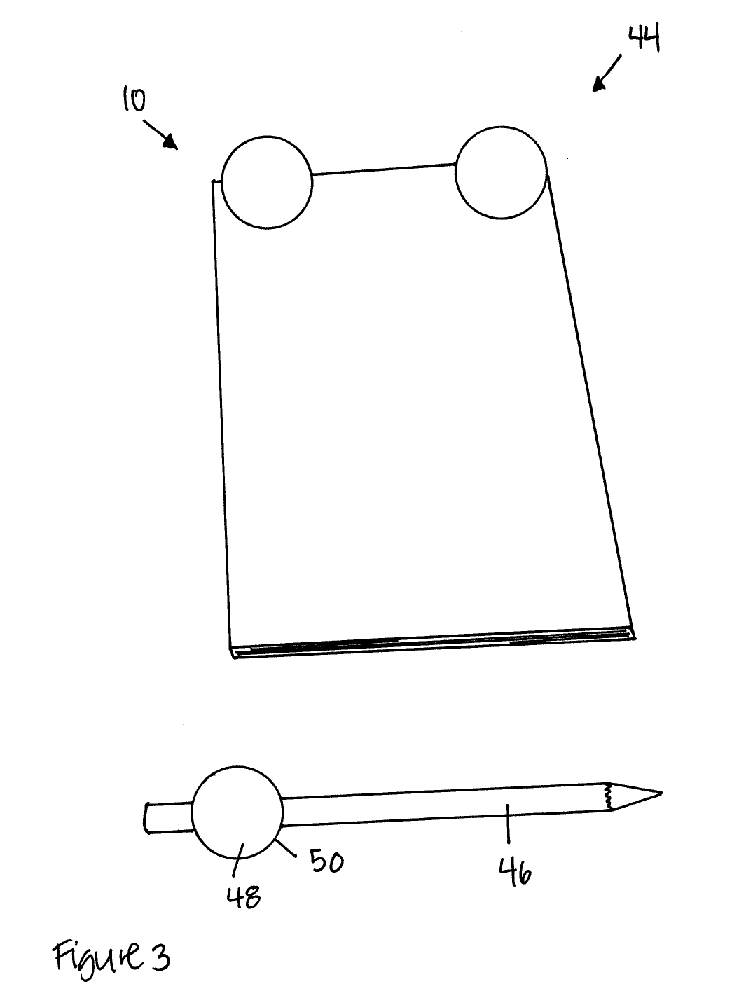

Referring now to FIG. 3, notepad assembly 44 is shown as including notepad 10 provided along with writing implement 46. According to some embodiments, writing implement 46 may include an ink pen, a pencil, a marker, and the like. It will be understood that writing implement 46 may be adapted to make markings on sheets of paper 22 having a waterproof coating. In particular, writing implement 46 may be adapted to leave substantially permanent markings on sheets of paper 22 regardless of the type of waterproof coating applied sheets of paper 22.

During use, writing implement 46 may be disposed proximate notepad 10 by way of attachment member such as suction cup 48 having end 50 adapted to releaseably retain at least a portion of writing implement 46. According to exemplary embodiments, end 50 may include a clip having flexible arms designed to exert compressive forces on writing implement 46 when writing implement 46 is inserted between the arms of the clip.

To assemble notepad 10, sheets of paper 22 are stacked upon one another to form pad 14. In one embodiment, once stacked, adhesive 24 is disposed along top edges 26 of sheets of paper 22 to join sheets of paper 22 together. Base member 12 is oriented with top surface 18 facing upwardly. The bottom surface of the last sheet of paper 22 is placed against top surface 18 of base member 12. Next, the portion of base member 12 extending above top edges 26 of sheets of paper 22 is folded over top edges 26 to overlap at least a portion of pad 14. More specifically, the length of the portion of base member 12 extending above top edges 26 should be of sufficient length that when folded over, a lower edge of the portion of base member 12 folded over pad 14 is substantially aligned with score lines 28 of sheets of paper 22.

Apertures are punched through region 34 where base member 12 overlaps pad 14. Next, securement members 32 are associated with apertures by inserting post 40 through an aperture and associating attachment member 38 with a terminal end of post 40. It will be understood that region 34 where base member 12 overlaps pad 14 is captured between head 36 and attachment member 38.

It will be understood that adhesive 24 applied to top edges 26 of sheets of paper 22 may also operate to further secure pad 14 to base member 12 if adhesive 24 contacts base member 12 before adhesive 24 cures. More specifically, adhesive 24 contacts at least a portion of top surface 18 of base member 12 as base member 12 is folded over pad 14.

In contrast, rather than being disposable, notepad 10 may be refillable by removing used or damaged pads 14 and replacing used pad 14 with a new pad 14. Pad 14 may be removed by first removing securement members 32 that join pad 14 to base member 12 and then removing pad 14. Next, a new pad 14 may be associated with base member 12 according to the steps described above.

In operation, pad 10 is attached to a surface such as a mirror in a bathroom or the wall of a shower stall by way of the attachment members 38. Attachment member 48 of writing implement 46 is disposed proximate pad 10 and writing implement 46 is releaseably attached to thereto. To utilize pad 10, an end user removes writing implement 46 from attachment member 48 and marks upon one or more of sheets of paper 22 with writing implement 46. To expose a clean sheet of paper 22, the end user detachably removes used sheet of paper 22 by tearing sheet of paper 22 along score line 28.

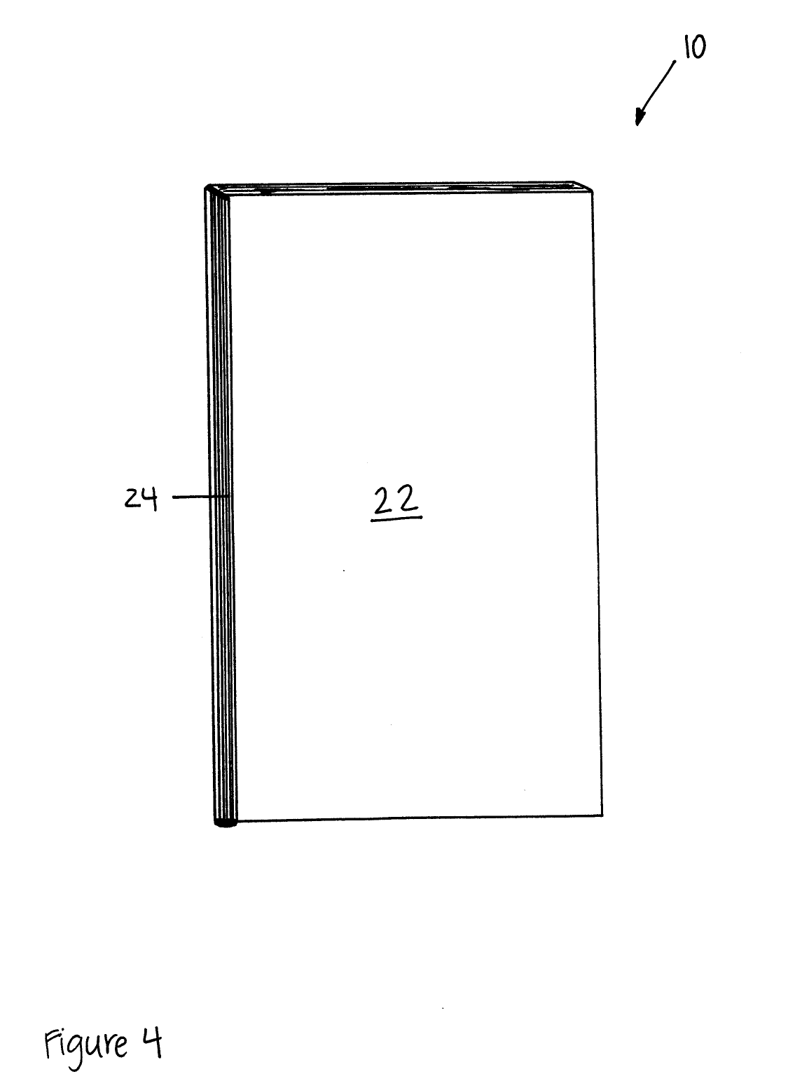

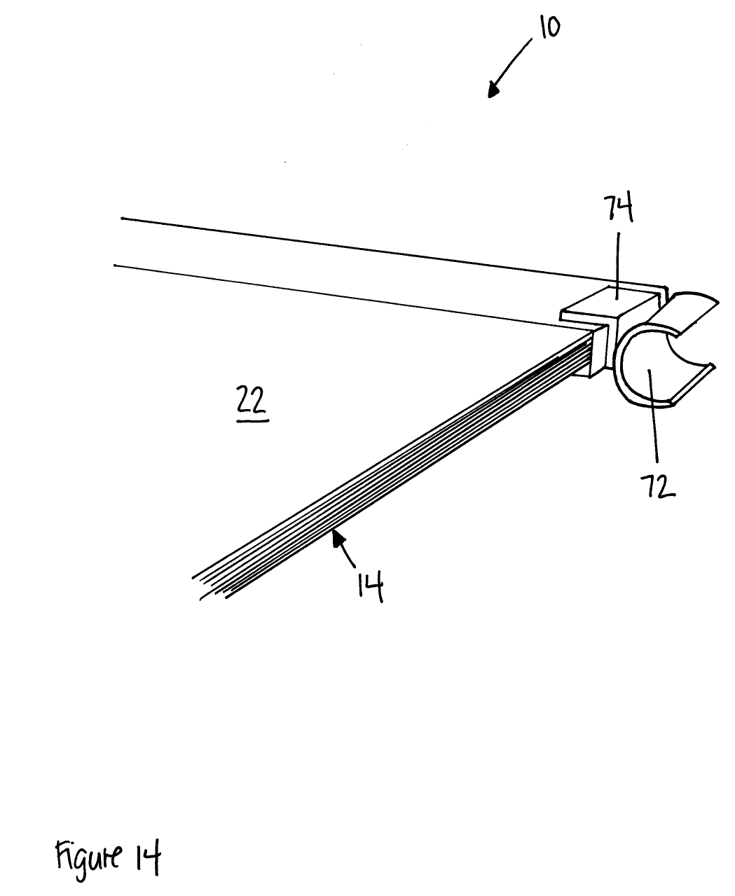

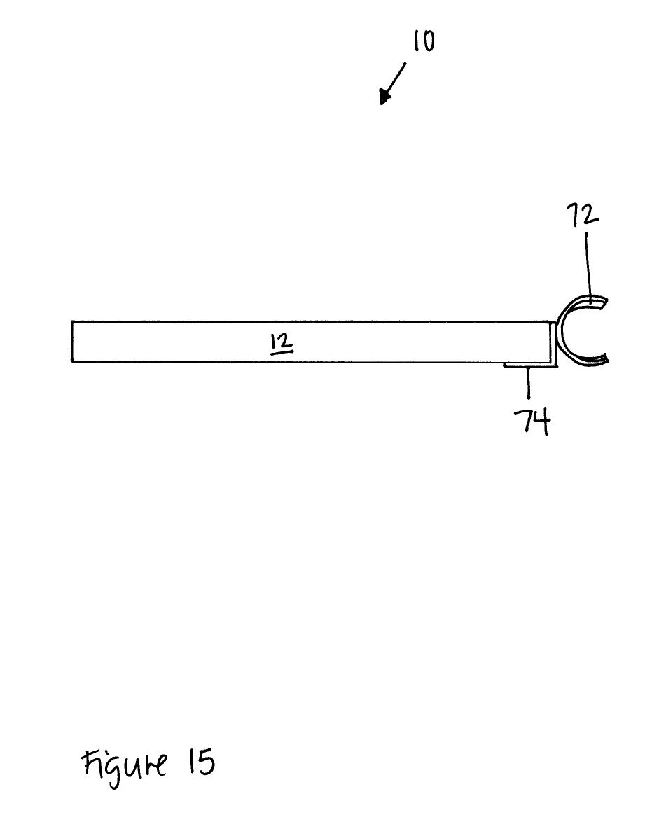

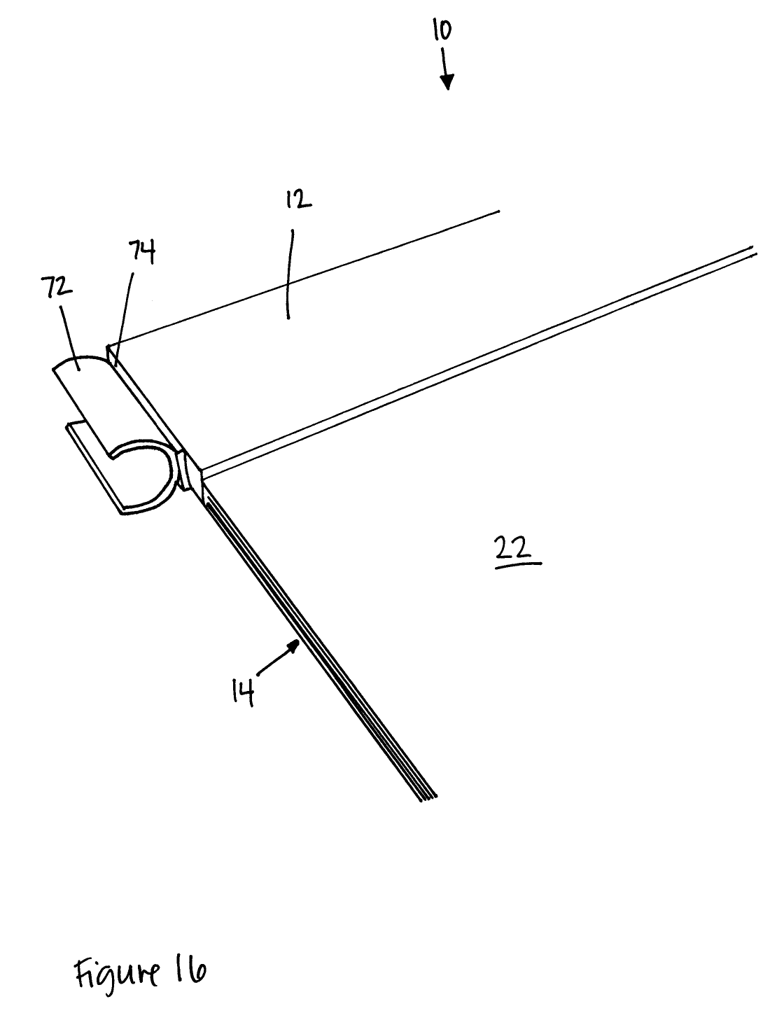

Referring now to FIGS. 4-16, pad 10 may comprise a plurality of different embodiments, configurations, attachments, and accessories.

As is shown in FIG. 4, pad 10 may include an edge having adhesive 24, whereby sheets of paper 22 are preferably peeled away one sheet at a time. In accordance with all embodiments of the present invention, pad 10 may optionally include base member 12 (not shown).

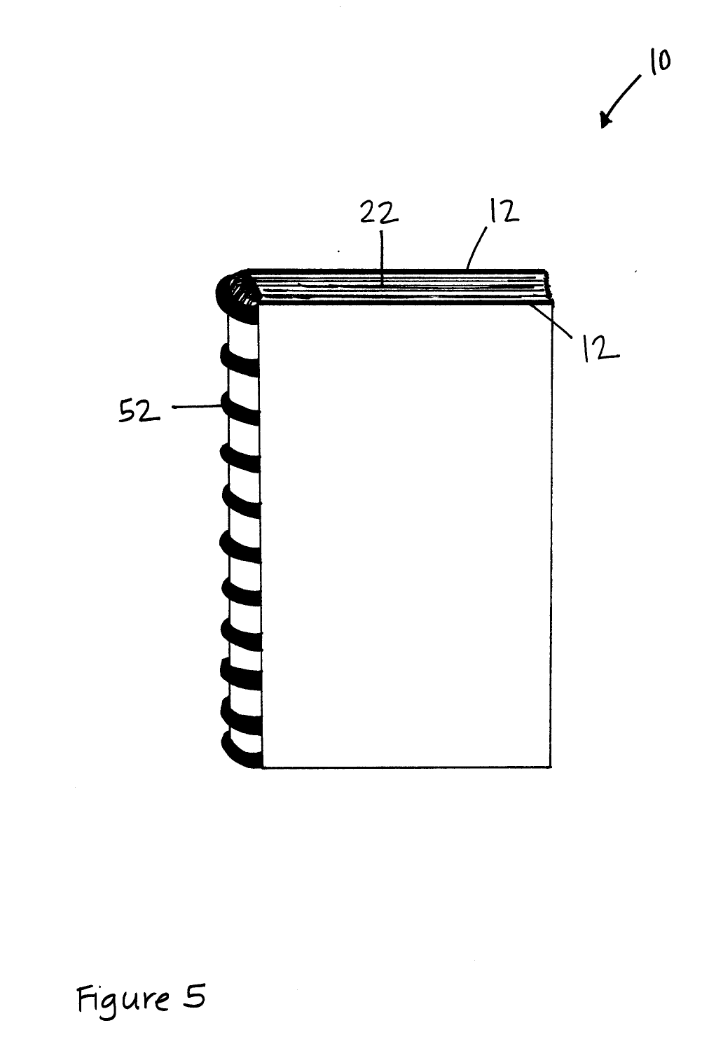

As is shown FIG. 5, pad/journal 10 may include plastic coil 52 for binding sheets of paper 22 together to form pad/journal 10.

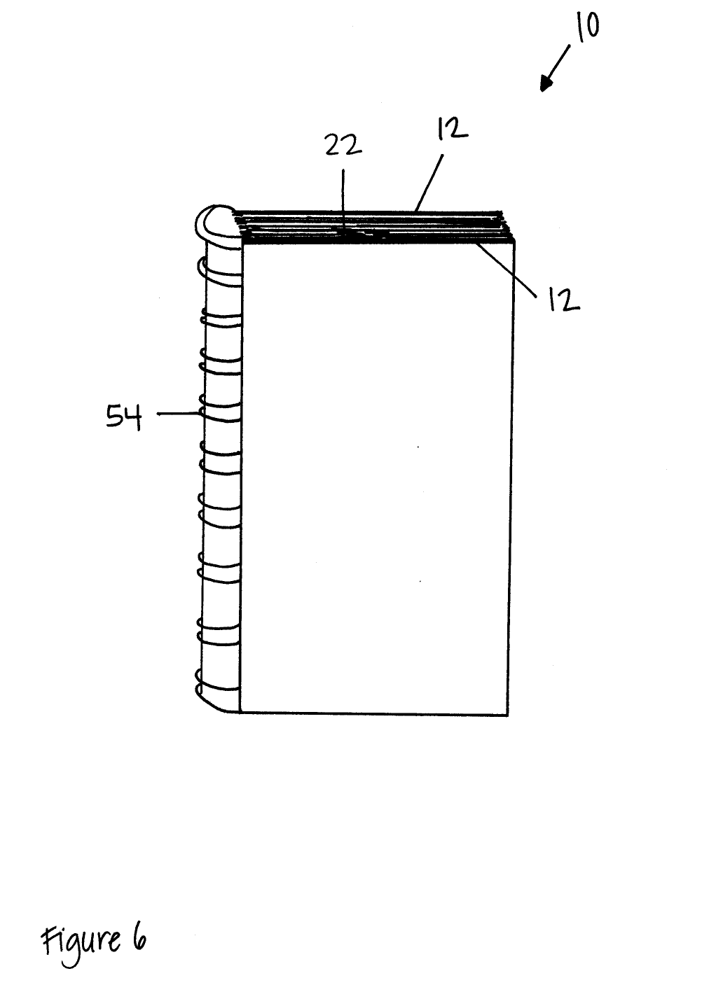

As is shown FIG. 6, pad/journal 10 may include loop wire 54 for binding sheets of paper 22 together to form pad/journal 10.

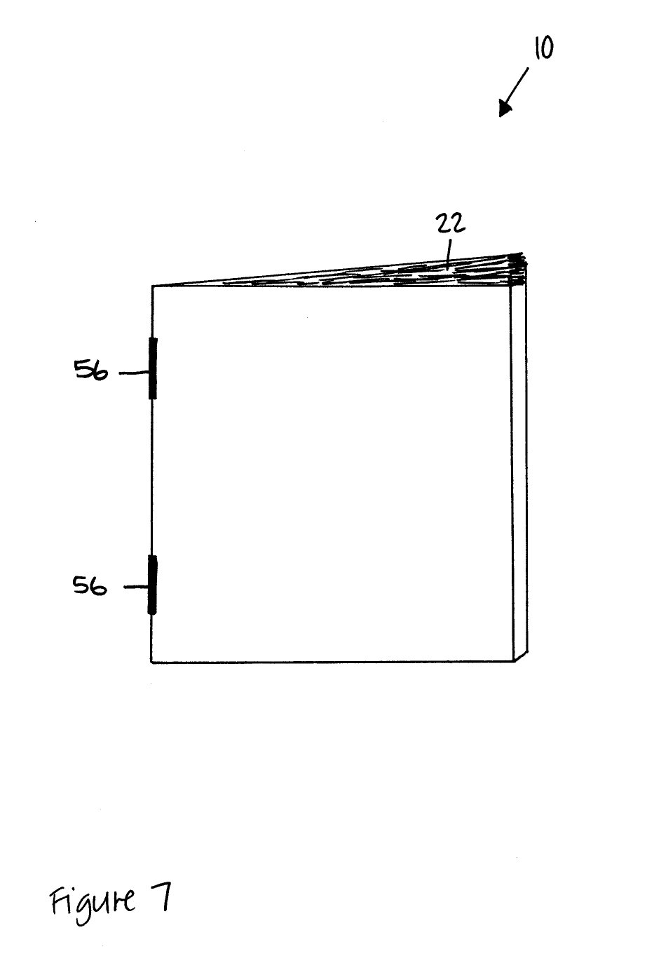

As is shown FIG. 7, pad/booklet 10 may include a saddle stitch or staples 56 for binding sheets of paper 22 together to form pad/booklet 10.

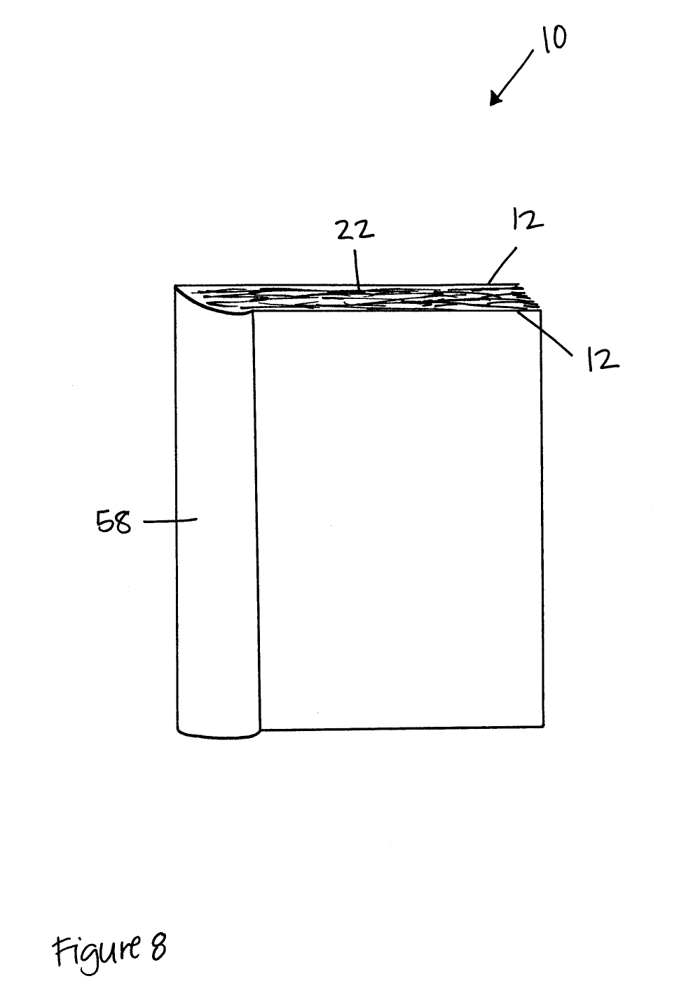

As is shown FIG. 8, pad/book 10 may include tape 58 for binding sheets of paper 22 together to form pad/book 10.

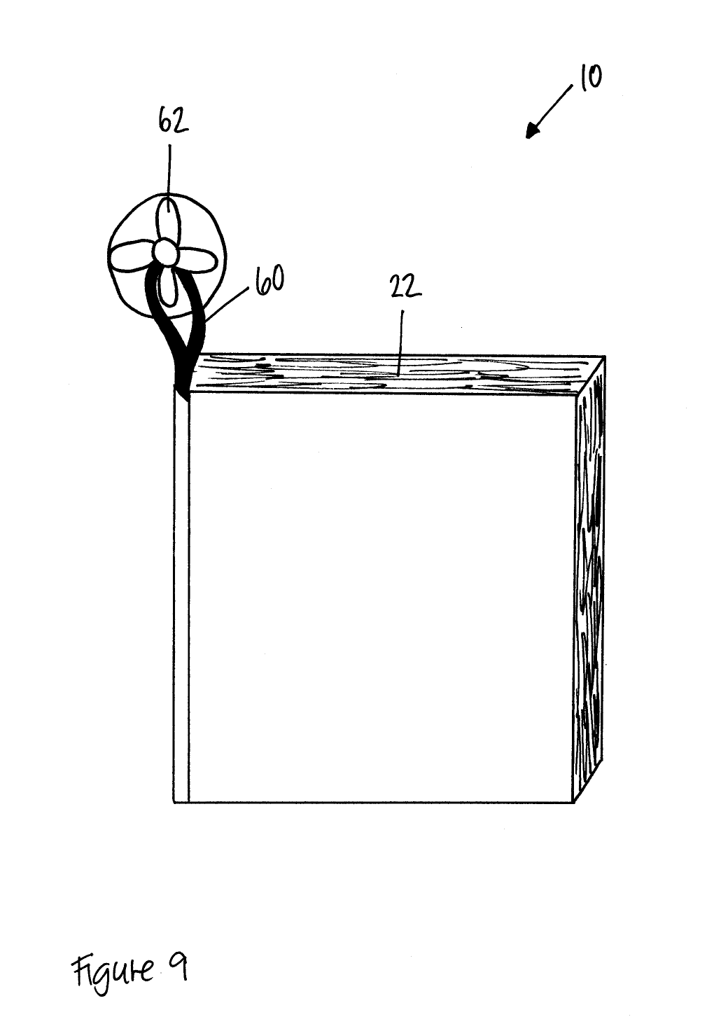

As is shown FIG. 9, pad 10 may include lanyard 60 for associating pad 10 with faucet handle 62 and/or a suction cup.

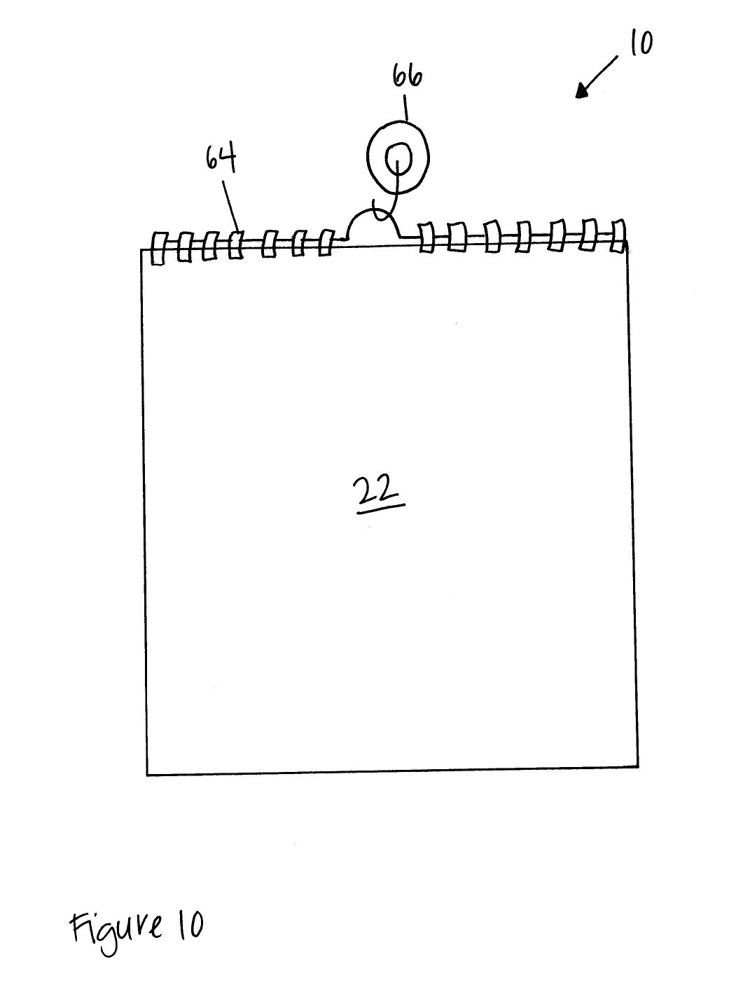

As is shown FIG. 10, pad 10 may include calendar coil 64 for associating pad 10 with a faucet handle and/or suction cup 66.

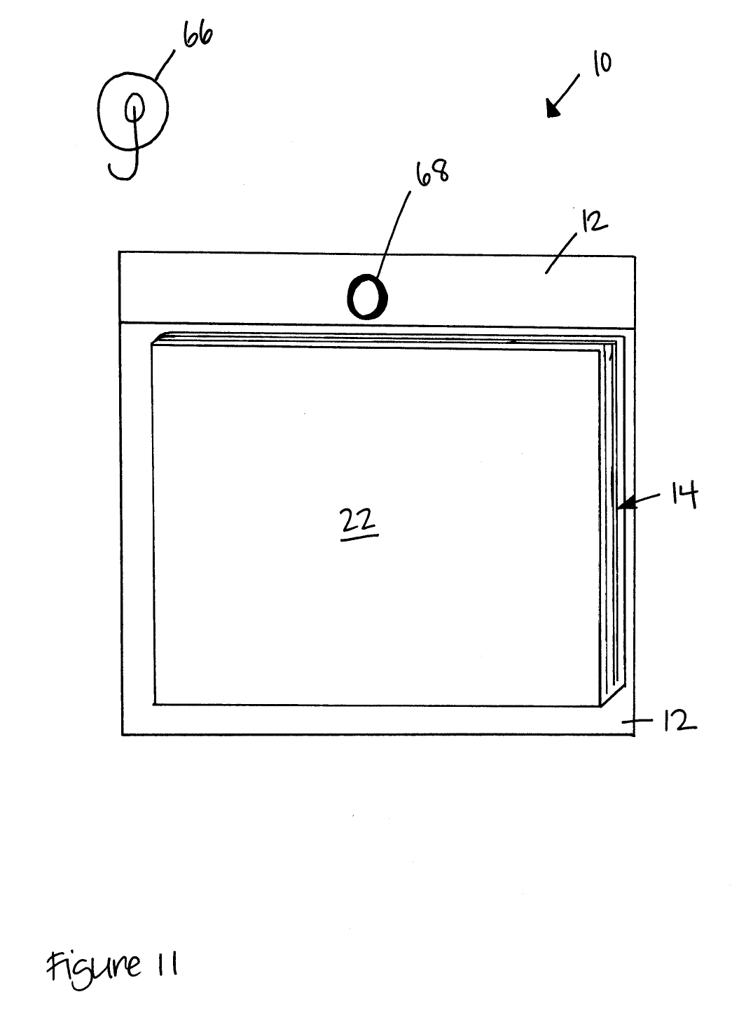

As is shown FIG. 11, pad 10 may include grommet 68 for associating pad 10 with a faucet handle and/or suction cup 66.

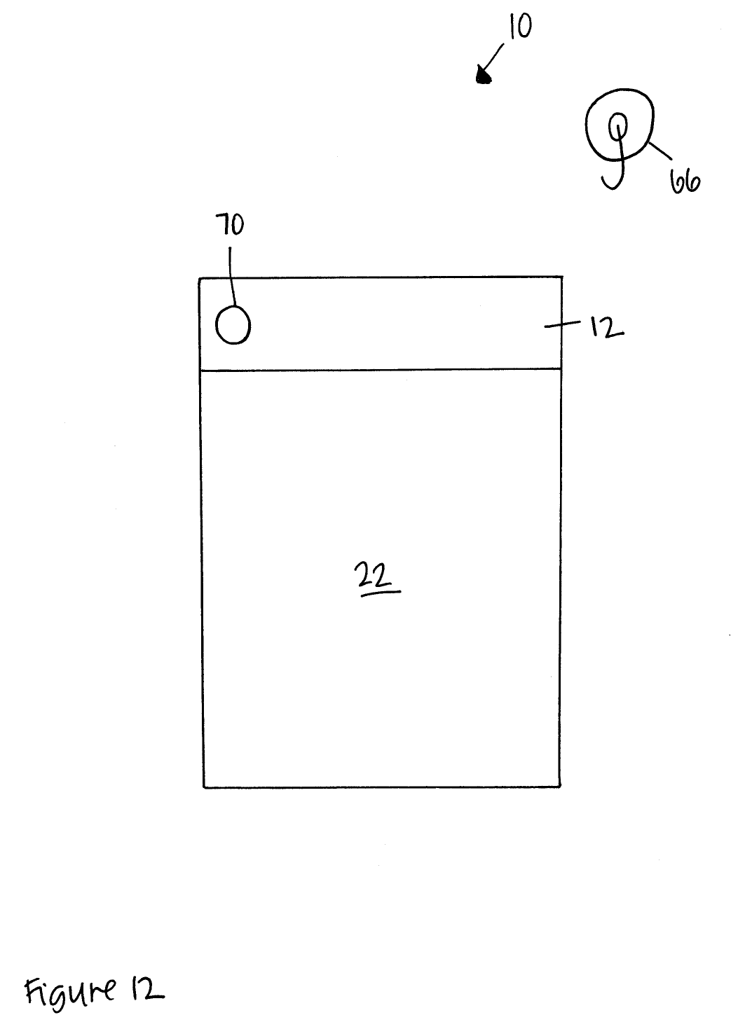

As is shown FIG. 12, pad 10 may include aperture 70 for associating pad 10 with a faucet handle and/or suction cup 66.

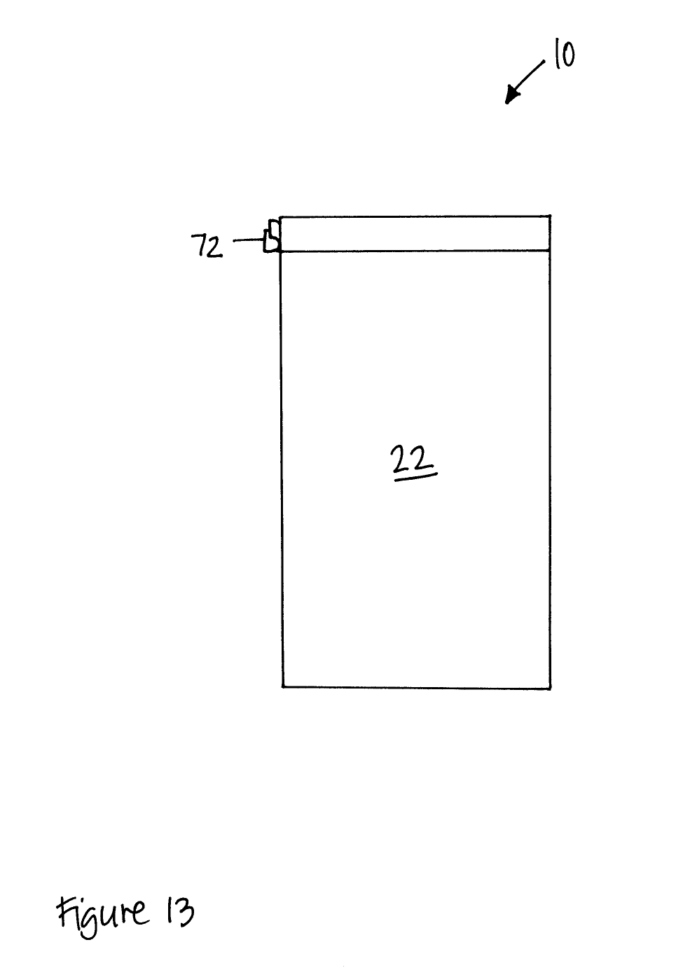

As is shown FIGS. 13-16, pad 10 may include C-clip 72 for releasably retaining a writing implement. C-clip 72 is secured to pad 10 via L-bracket 74.

The present invention is also directed to a method of using a sheet of paper, comprising the steps of: providing a sheet paper (e.g., 22) having a top surface and a bottom surface, wherein the sheet of paper comprises at least one of a natural and synthetic material which is at least one of water resistant and waterproof; moistening (e.g., wetting, licking, dipping, spraying, etcetera) at least one of the top and bottom surfaces of the sheet of paper with an aqueous liquid (e.g., water, saliva, etcetera); applying the sheet of paper to a surface (e.g., a substantially non-porous and/or substantially vertical surface); and releasably securing the sheet of paper to the surface with the aqueous liquid. In accordance with the present invention, Applicant surprisingly discovered that, unlike conventional paper, the paper of the present invention is releasably securable to a substantially vertical and substantially non-porous surface (e.g., glass, mirror, window, shower wall, tub wall, door, refrigerator, etcetera) for an extended period of time without the use of traditional adhesives found, for example, on Post-it® type notes. Indeed, experimentation validated that the sheets of paper remain secured to glass for at least 30 minutes, 1 hour, 2 hours, 4 hours, and 8 hours using only human saliva. In this embodiment, the sheet of paper is preferably adhesive free—other than for the aqueous liquid.

It will be understood that the top and or bottom surfaces of the sheet of paper may include indicia, such as, but not limited to, grids, musical bars, quotes, verses, cross words, puzzles, games, slogans, etcetera.

The foregoing description merely explains and illustrates the invention and the invention is not limited thereto except insofar as the appended claims are so limited, as those skilled in the art who have the disclosure before them will be able to make modifications without departing from the scope of the invention.

What is claimed and desired to be secured by Letters Patent of the United States is:

1. A notepad for use in wet environments, the notepad comprising:
a base member having a top surface and a bottom surface;
a plurality of sheets of natural and/or synthetic water resistant and/or waterproof paper stacked together to form a pad, the pad including a top sheet, a bottom sheet, and a top edge;
wherein at least a portion of the base member is folded over and covers the top edge of the pad; and
one or more securement members extending through a region where the base member overlaps the pad to associate the pad with the base member, the securement members being adapted to releaseably connect the notepad to a surface.

2. The notepad according to claim 1, wherein at least one of the top surface and the bottom surface of the base member include a waterproof coating.

3. The notepad according to claim 1, wherein the top edge of the pad includes an adhesive, wherein when the pad is associated with the base member, the adhesive contacts at least a portion of the top surface of the base member when the base member is folded over the pad.

4. The notepad according to claim 1, wherein each of the plurality of sheets of paper include a score line extending along a length thereof, the score line spaced apart from a top edge of the sheet of paper such that a lower edge of the base member overlapping the top edge of the pad is substantially aligned with the score line.

5. The notepad according to claim 1, wherein the securement members include a head, an attachment member, and a post extending therebetween, the post extending through at least a portion of the region where the base member overlaps the pad.

6. The notepad according to claim 5, wherein at least a portion of the region where the base member is folded over the pad is captured between the head and the attachment member.

7. The notepad according to claim 5, wherein the attachment member includes at least one of a suction cup and a hook.

8. A notepad assembly for use in wet environments, comprising:
a notepad comprising:
a base member having a top surface and a bottom surface;
a plurality of sheets of natural and/or synthetic water resistant and/or waterproof paper stacked together to form a pad, the pad including a top sheet, a bottom sheet, and a top edge;
wherein at least a portion of the base member is folded over and covers the top edge of the pad; and
one or more securement members extending through a region where the base member overlaps the pad to associate the pad with the base member, the securement members being adapted to releaseably connect the notepad to a surface;
at least one writing implement adapted for marking sheets of paper having a waterproof coating; and
at least one securement member adapted to releaseably retain the at least one writing implement, the at least one securement member adapted to releaseably attach to a surface.

9. The assembly according to claim 8, wherein at least one of the top surface and the bottom surface of the base member include a waterproof coating.

10. The assembly according to claim 8, wherein the top edge of the pad includes an adhesive, wherein when the pad is associated with the base member, the adhesive contacts at least a portion of the top surface of the base member when the base member is folded over the pad.

11. The assembly according to claim 8, wherein each of the plurality of sheets of paper include a score line extending along a length thereof, the score line spaced apart from a top edge of the sheet of paper such that a lower edge of the base member overlapping the top edge of the pad is substantially aligned with the score line.

12. The assembly according to claim 8, wherein the securement members include a head, an attachment member, and a post extending therebetween, the post extending through at least a portion of the region where the base member overlaps the pad.

13. The assembly according to claim 12, wherein the region where the base member is folded over the pad is captured between the head and the attachment member.

14. The assembly according to claim 12, wherein the attachment member includes at least one of a suction cup and a hook.

15. A method of using a sheet of paper, comprising the steps of:
providing a sheet paper having a top surface and a bottom surface, wherein the sheet of paper comprises at least one of a natural and synthetic material which is at least one of water resistant and waterproof;
moistening at least one of the top and bottom surfaces of the sheet of paper with an aqueous liquid;
applying the sheet of paper to a surface; and
releasably securing the sheet of paper to the surface with the aqueous liquid.

16. The method according to claim 15, wherein the step of providing a sheet of paper comprises the step of providing adhesive free paper.

17. The method according to claim 15, wherein the step of providing a sheet of paper comprises the step of providing a sheet of paper having indicia associated with at least one of the top and bottom surfaces of the sheet of paper.

18. The method according to claim 15, wherein the step of applying the sheet of paper to a surface includes the step of applying the sheet of paper to a substantially non-porous and substantially vertical surface.

19. The method according to claim 15, wherein the step of releasably securing the sheet of paper to the surface includes the step of releasably securing the sheet of paper to the surface for at least one hour.

20. The method according to claim 15, further comprising the step of removing the sheet of paper from the surface by an individual who did not apply the sheet of paper to the surface.
